(19) United States
(12) Patent Application Publication
(10) Pub. No.: US 2015/0203378 A1
(43) Pub. Date: Jul. 23, 2015

(54) COFFEE MACHINE COMPRISING AN ELECTROLYTIC CELL FOR PRODUCING BASIC WATER

(71) Applicant: Hanspeter STEFFEN, Alchenstorf (CH)

(72) Inventor: Hanspeter Steffen, Alchenstorf (CH)

(21) Appl. No.: 14/399,720

(22) PCT Filed: May 7, 2013
(86) PCT No.: PCT/CH2013/000078

§ 371 Date: Mar. 23, 2015

(30) Foreign Application Priority Data
May 8, 2012 (CH) 640/12

(51) Int. Cl. C02F 1/461; A47J 31/40; A47J 31/44

(52) U.S. Cl. CPC C02F 1/46104; A47J 31/4403; A47J 31/407; A47J 31/4489; C02F 1/46109; C02F 2001/46133; C02F 2201/46105

(57) ABSTRACT

Disclosed is a coffee-tea extraction machine comprising one or a plurality of electrolytic cells that include two or more diamond electrodes or corresponding suitable stable metal electrodes or corresponding suitable stable metal electrodes for producing slightly alkaline water having a pH of 8.2 to 8.6 and for electrochemically breaking up the water molecule cluster chains of 14 to 18 molecules into clusters containing two to three molecules. Said coffee-tea extraction machine is characterized in that the solvency and extractive capacity of the brewing water in the coffee-tea machine triples or quadruples and the resorption potential through intestinal cell membranes doubles or triples. Said improved parameters make the extraction of coffee powder and tea powder in a metal filter, in capsules and filter pads in the machine in combination with heat and pressure more efficient, resulting in substantially improved extraction of flavors and ingredients of coffee and tea and an optimal sensory quality of the beverages with respect to the acidity and bitterness of coffee and tea. In addition, resorption of the ingredients through intestinal cell membranes is improved and two to three times faster. Moreover, the enormous extractive capacity of said combined technology makes it possible to admix probiotics, plant substances to the coffee powder or tea powder in order to obtain an added nutritional benefit besides providing the enjoyment of a tasty beverage.

### STATE OF THE ART

Up to now, electric coffee machines and automatic coffee machines or tea machines, respectively, were mainly equipped, with a pressure pump, a water heating device and/or steam device, and a coffee extraction chamber for loose coffee powder or tea powder, respectively, capsules or filter pads. It is to be shown by means of the new invention that the extractive capacity of the water as coffee extractant and solvent can be tripled or quadrupled with the help of a novel electrolysis technology and the use of electrolyzed water, made with boron-doped full diamond electrodes or platinum-titanium or chemically stable, metallic mixed electrodes comprising an electric overpotential, by means of electrochemically breaking up the water molecule clusters of 14-18 molecules into 2-3 molecules. As a result, essential flavors, which serve to enhance and improve flavor, are extracted better. A maximum and optimum extraction of the coffee or tea powder, respectively, is thus not only attained by means of heat and steam pressure, but additionally by means of the highly increased solvency and extractive capacity of the water, which leads to the triple or quadruple increase of the solvent and extracting water molecule dipoles due to the highly increased solvency and extractive capacity of the water.

Thanks to the electrolysis, the brewing water is furthermore sterilized and also becomes slightly alkaline due to electrochemical oxidations prior to the extraction of the coffee or tea powder, which leads to a significant improvement of the sensory perception of the coffee or tea beverage. This is understandable, because protons (H+) are converted to H2 (hydrogen) in response to the electrolysis and because OH—-ions thus remain, which increase the pH value. This is also why the acid capacity increases to pH 4.3 from 1.37 mmol/L to 3.42 mmol/L.

In addition, the intestinal intestine and body cell resorption through semi-permeable cell membranes is doubled to tripled thanks to the molecule cluster size, which is 3- to 4-times smaller, which leads to an improved and faster absorption of caffeine and other healthy ingredients in coffee or tea and which furthermore has a positive effect on the cell metabolism, in that toxic substances and oxidative radicals are flushed out of body cells and can lead to an improved individual state of health. Thanks to the new integrated electrolysis technology in coffee or tea machines, respectively, additional probiotic additives, which are created from plant substances, can also be added as health-related, nutritional enhancements and additional benefit in coffee and tea beverages.

The invention is inventive new and innovative. Similar technologies are not known to the inventor for the preparation of coffee and tea using a machine by means of electrolysis of the brewing water for simultaneously improving the extraction, the sensory perception and the resorption of the beverage ingredients.

### TECHNICAL FIELD

It is to be shown by means of the new invention that not only a slightly alkaline extraction water, which leads to the improvement of the sensory perception, can be produced with the help of the novel integrated water electrolysis technology in coffee or tea machines, respectively, using electrolyzed water, produced with boron-doped diamond electrodes or other chemically stable, metallic electrodes comprising an electric overpotential, but that the solvency and extractive capacity of the water can also be tripled or quadrupled thanks to the electrochemical breaking up of the water molecule clusters of 14-18 molecules into 2-3 molecules and that the cellular resorption potential and the resorption speed of water and caffeine and other added probiotic plant-based active substances can furthermore be doubled or tripled.

### INTRODUCTION

### Electrolytically Produced, Oxidative Water (EOW)

Electrolytically oxidative water (EOW) or chemically active water does not destroy microorganisms, such as viruses, bacteria, fungi, yeasts and protozoa by means of oxidative radicals in a chemical manner, but in a physical manner.

Due to its high oxidative reduction potential (ORP), “active water” damages the cell wall membranes of pathogens.

The pathogenic organism is compromised, which leads to an osmotic or hydrogenic overload in the interior of the cell.

The damaged cell membranes allow for an increased water transfer between the cell membranes, which leads to a hydrogenic flooding of the cells, and the cells are filled more quickly than they can get rid of the water.

This fact leads to a bursting of the cells or to the death of the cells, respectively, within a few seconds due to pressure explosion.

Due to the fact that this is a physical destruction principle, it is verifiable that this does not result in resistances in pathogens.

Principle of the electrolysis (see FIG. 1): example of an electrolysis with a zinc iodide solution (any electrode material):

When connecting two small metal plates (electrodes) to a cable and to a device, which generates direct current, e.g. a battery or a rectifier—and when transferring these small plates into a beaker glass comprising an aqueous solution (any ions) and when now applying a voltage, a substance, the ions of which are present in the solution, is formed at both small metal plates.

The voltage source effects an electron deficiency in the electrode, which is connected to the positive pole (anode) and an electron excess in the other electrode, which is connected to the negative pole (cathode). The aqueous solution between the cathode and anode contains electrolytes, which are positively or negatively charged ions. The positively charged cations in an electrolytic cell move to the negatively charged cathode by applying a voltage (attraction of opposite charges). At the cathode, they absorb one or a plurality of electrons and are thus reduced.

The opposite process takes place at the anode. There, the negatively charged anions release electrons, that is, they are oxidized. The number of the electrons used up by the reduction at the cathode corresponds to the electrons absorbed by the anode. In response to the electrolysis of an aqueous saline solution, the same volume of hydrogen gas as of chlorine gas is created. In response to the electrolysis of water, twice as much hydrogen gas as oxygen gas is created, because the two positively charged protons of a water molecule shift to the cathode and must in each case absorb an electron at that location, so that hydrogen forms, while the double negatively charged oxygen anion must release two electrons at the anode so as to connect to the oxygen molecule.

The voltage, which must at least be applied for the electrolysis, is identified as separation potential. In the case of the electrolysis of water or in the case of aqueous saline solutions, this is also referred to as the decomposition voltage. This voltage (or a higher voltage) must be applied, so that the electrolysis runs at all. For every substance, for every conversion of ions into two-atomic or polyatomic molecules, the decomposition voltage, the separation potential, can be determined by means of the redox potential. Much other important information for the electrolysis, for example for the electrolytic decomposition of metal electrodes in acid or for reducing decomposition voltage by changing pH values, is obtained from the redox potential.

For example, it can be calculated from the redox potential that the formation of oxygen at the anode in response to the electrolysis of water in basic solution (decomposition voltage: 0.410 V) runs under a lower voltage than in acidic solution (decomposition voltage: 1.23 V) or in neutral solution (decomposition voltage: 0.815 V). In contrast, hydrogen is formed more easily at the cathode under acidic conditions than under neutral or basic conditions). In the event that a plurality of cations, which can be reduced, are present in an electrolyte solution, those cations, which have a more positive (less negative) potential in the redox series (voltage series), which are thus as close as possible to the 0 potential of the proton hydrogen electrode voltage, are initially reduced at the cathode according to the redox series. Normally, hydrogen is formed at the cathode in response to the electrolysis of an aqueous ion-containing solution. When a plurality of anion types, which can be oxidized, is present, those anion types are preferred initially, which are as close as possible to the zero-point of the voltage in the redox series, thus those, which have a weaker positive redox potential. Normally, oxygen and not chlorine is thus created at the anode in response to the electrolysis of aqueous NaCl. After exceeding the decomposition voltage, the intensity of current also increases proportionally with the increase of voltage. According to Faraday, the quantity by weight of an electrolytically formed substance is proportional to the amount of current, which flowed (intensity of current multiplied by the time). An amount of current of 96485 C (As)=1 Faraday is required for the formation of 1 g of hydrogen (approx. 11.2 liters, two electrons are required in response to the formation of a hydrogen molecule) from an aqueous solution. In response to an intensity of current of 1 A between the electrodes, the formation of 11.2 liters of hydrogen thus takes 26 hours and 48 minutes.

In addition to the redox potential, the overvoltage (the overpotential) is also significant. Due to kinetic inhibitions at electrodes, a voltage, which is significantly higher than is calculated from the calculation of the redox potentials, is often required. Depending on the material characteristic of the electrodes, the overvoltage effects can also change the redox series, so that other ions than would have been expected according to the redox potential, are oxidized or reduced. Shortly after switching off an electrolysis, a current spike in the other direction can be detected by means of an amperemeter. In this short phase, the reverse process of the electrolysis, the formation of a galvanic cell, starts. Current is hereby not used for the conversion, but current is produced for a short period of time; this principle is used in the case of fuel cells.

If a break-up of individual molecules or bonds is forced by means of an electrolysis, a galvanic element, the voltage of which counteracts the electrolysis, acts at the same time. This voltage is also identified as polarization voltage.

As an additional effect in the water-electrolysis process, the production of OH hydroxide ions at the surface of the electrodes cuts down the water molecule clusters of 14-18 molecules to 2-3 molecules per cluster in an electrochemical manner, which leads to a triple or quadruple increase of the solvency of the water and which doubles or triples the resorption potential through cell membranes. In addition, the water becomes slightly alkaline in response to the electrolysis process.

This is understandable, because protons (H+) are converted to H2 (hydrogen) in response to the electrolysis and because OH−-ions thus remain, which increase the pH value. This is also why the acid capacity increases to pH 4.3 from 1.37 mmol/l to 3.42 mmol/l.

### Electrodes

There are only a few anode electrodes, which remain inert during the electrolysis, which thus do not dissolve at all. Boron-doped full diamond is the newest material, which does not dissolve at all during an electrolysis. Inhibition phenomena at the anode, which lead to an overvoltage in response to the formation of oxygen, can mainly be observed in the case of full diamond anodes (overvoltage: 3-4 V) and platinum electrodes (1.2 V. Chlorine instead of oxygen is thereby created in response to the electrolysis of an aqueous saline solution. At zinc, lead (overvoltage: 0.78 V) and in particular pool cathodes (0.80 V), hydrogen protons show a significant overvoltage and the formation of hydrogen only takes place in response to a much higher voltage. The significant overvoltage of hydrogen at the pool cathode, in which the sodium is bonded as amalgam and is thus removed from the equation, is used for technically producing sodium hydroxide. Due to the significant overvoltage at this electrode in response to the formation of hydrogen, the redox series changes and sodium cations instead of hydrogen protons now shift to the pool cathode.

### Electrolysis of Water

The electrolysis of water consists of two partial reactions, which run at the two electrodes. The electrodes dip into water, which is made slightly conductive due to the mineral ions, which are present, whereby oxygen is then obtained. Positively charged hydronium ions (H3O+) shift to the negatively charged electrode (cathode) in the electrical field, where they each absorb an electron. Hydrogen atoms, which combine with a further H-atom, which was created by means of reduction, to form a hydrogen molecule are created thereby. What remains are water molecules in 2 and 3-molecular cluster form.

2 H₃O⁺→2 e⁻→H₂+2 H₂O

The separated, gaseous hydrogen rises at the cathode.

The negatively charged hydroxide ions shift to the positively charged electrode (anode). Each hydroxide ion releases an electron to the positive pole, so that oxygen atoms are created, which combine to form oxygen molecules.

The remaining H+ ions are neutralized immediately into water molecules by means of hydroxide ions.

4 OH⁻→O₂+2 H₂O+4 e⁻

Here, the separated oxygen also rises as colorless gas at the anode. The total reaction equation of the electrolysis of water is:

4 H₃O⁺+4 OH⁻→2 H₂+O₂+6 H₂O

The hydronium and hydroxide ions on the left-hand side originate from the autoprotolysis of the water:

8 H₂O→4 H₃O⁺+4 OH⁻

The electrolysis equation can thus also be expressed as follows:

8 H₂O→2 H₂+O₂+6 H₂O

or, after reducing the water, respectively: 2 H₂O→2 H₂+O₂

### Hydroxide Ion

The hydroxide ion is a negatively charged ion, which is created when bases react with water. Its chemical formula is OH⁻.

A general base B reacts with water according to the following formula:

B+H₂O [symbol] HB⁺+OH⁻

The pH value of the created solution can be determined by means of the concentration of the hydroxide ions. For this purpose, the so-called poH value is first calculated.

pOH=−log c(OH⁻)

And from this, the pH value:

pH=k−pOH

Each temperature has a k in each case.

Under normal conditions, k=−14.

Hydroxide ions are also contained in pure water at 20° C. in a concentration of 10⁷ mol 1¹. This is associated with the autoprotolysis of the water according to the following reaction equation:

H₂O+H₂O [symbol] H₃O⁺+OH⁻

### Basic Water

Basic water removes the bitter taste of coffee and tea and makes in particular coffee more easily digestible.

### Approval

Our own early experiments and other test results led to the filing of license applications with the FDA (Food and Drug Administration, USA), which granted a general approval for electrolysis water in December of 2002 and marked it with the status “GRAS” (Generally Regarded as Safe).

Electrolyzed oxidative water obtained FDA (USA Food and Drug Administration), USDA (United States Department of Agriculture) and EPA (USA Environmental Protection Agency) approval for general applications in the field of food products, for the food product surface disinfection, for milk, meat and restaurant-related applications.

The corresponding pages of the authorization numbers of the FDA and USDA are 21 CFR 173, 178, 182, 184 and 198.

The EPA authorization and publication page is 40 CFR 180.940 and that of the National Organic Program is 21 CFR 178.1010.

In Japan, electrolysis water has been approved as food additive.

### ILLUSTRATION OF THE INVENTION

### System Components

A coffee or tea machine, respectively, which is equipped with electrolysis technology, includes the following technical components and process steps:

### Technical Aids

An electric coffee or tea machine, respectively, or corresponding machines comprising an integrated electrolysis technology (electrolytic cell comprising electrodes) include conventional and preferably the following technical components:

### (According to Drawing in ANNEX 1)

A Liquid container comprising filler neck comprising cover made of a non-oxidizing material. Automatic water-level control. Connecting piece or hose to booster pump comprising integrated automatic return flow shut-off valve.

B Electrolytic cell supplied with approximately 36 Volts of electric voltage integrated in the pump intake port upstream of booster pump.

C Water pressure increase pump with approx. 12 atm pressurization, approx. 0.5 liters of throughput per minute, preferably 110 or 220 V, respectively, comprising connecting hose to electrolytic cell(s) comprising diamond electrodes (or of another suitable electrode material comprising electric overpotential).

D Water heating coil or heating cylinder.

E Extraction container, capsule or filter pad chamber.

F Spout for coffee and hot water comprising a separate steam generator nozzle.

G Electric ON/ OFF switch, control electronics for liquid control, coffee quantum switch, coffee level gauge or capsule or filter pad disposal mechanism, coffee ground emptying or rinsing

H Power plug 110V/220V 50-60 Hz

I 1 or a plurality of connecting hoses comprising brackets to electrolytic cell(s)

K 1 or a plurality of electrolytic cells comprising 2 or a plurality of diamond electrodes, each comprising 2 plus/minus connecting sleeves and in each case plus/minus 2 electrical cables to electrical distribution station comprising fuse box and in each case connected to the spray valves of the windshield wiper sprayer via a hose.

L 1 electrical control of the electrolytic cell(s) comprising electrode dipole reversal.

M In each case 2 electrical connecting cables plus/minus to electrolytic cell(s)

N Electrical control comprising programming station also for the decalcification process

### Preparation Of The Extracting Coffee or Tea Water, Respectively, by Means of Electrolysis.

The extracting coffee or tea water can be prepared directly by means of the electrolytic cell, which is integrated in the machine, by means of the new used electrolysis method.

The new method is implemented by a water electrolysis, preferably by means of full diamond electrodes. A slightly alkaline water having a pH of between 8.2 and 8.8 is created thereby. In addition to OH— and hydroxyl groups, O2 is also produced.

In response to the electrolysis of water together with the minerals, which appear in the drinking water by nature, oxidizing molecules, such as reducing peroxide disulfate, peroxide diphosphate and percarbonate are also created.

They guarantee the sterility of the water, which can be important specifically in 3rd-world countries, where a clean water supply is oftentimes not guaranteed.

The hydroxide ions OH—, which are formed at the electrodes, break up the water molecule clusters of 14-18 molecules into 2-3 molecules, which triples or quadruples the solvency of the water and which doubles or triples the cell resorption.

These new characteristics of the electrolyzed coffee or tea brewing water contribute significantly to the extraction efficiency of coffee and tea powder and increase the concentration of flavors and ingredients!

### Solution of the Task

The solution of the task is defined by the features of the independent patent claims. According to the invention, the new coffee machine device technology or tea machine device technology, respectively, for producing slightly alkaline brewing water using electrolyzed cold water and with the help of oxidative and reducing radicals and dipole water molecules, produced in an electrolytic cell, preferably comprising boron-doped diamond electrodes, integrated in an electrical coffee-tea machine or automatic machine, shows the type of the electrochemically produced substances, in particular the specific characteristics of the electrolyzed, oxidative and reducing water, the production thereof, the pH value thereof and the electrochemical break-up of water molecule clusters of 14 to 18 molecules into 2 or 3 molecules, the redox potential thereof or its concentration of dipole molecules, respectively.

The invention, with regard to the new coffee-tea machine technology, shows the technical embodiment and application relating to the new integrated components of the electrolytic cell in a coffee-tea machine and the interconnected pressure increase pump, for producing slightly alkaline brewing water comprising a tripled or quadrupled solvency power and comprising a doubled or tripled resorption potential.

The invention forms an integrated system, in which the technical components for the electrolytic production of numerous dipole molecular structures in the water, preferably by means of full diamond electrodes, which are integrated in a coffee-tea machine or automatic machine, together with the corresponding conventional components.

The focus of the innovation is thereby not only the technical design in the combination of a conventional coffee tea extraction machine comprising an electrolytic cell for producing slightly alkaline water for improving the sensory perception of the beverage in an electrolytic cell without membrane, but also the new electrochemical break-up technology of the water molecule clusters of 14-18 molecules per cluster into 2-3 water molecules or clusters, which triples or quadruples the solvency of the coffee-tea brewing water and which doubles or triples the intestinal cell resorption of extraction ingredients.

The process techniques in an electrical automatic coffee-tea machine were optimized in intensive tests, concentrations of dipole molecule clusters in the water were specified and the specific parameters were adapted to the technical demands and extraction times were determined as well, for attaining a perfect beverage quality in the case of coffee and tea.

During long research and development work in the laboratory and in practical use, the inventor tested and perfected the technically newly-developed integrated water-electrolysis technology in combination with a coffee-tea extraction machine and attained a sensory beverage quality in the case of coffee and tea, which has not been reached to date, because the extractive capacity of the brewing water can be extracted and made available thanks to the number of water dipoles, which is tripled or quadrupled and which can triple or quadruple the solvency and extractive capacity of the brewing water, in that essential aromas and flavors do not get lost in the case of coffee and tea. In addition, coffee and tea powder can also be saved at the same time.

According to the knowledge of the inventor, an automatic coffee-tea extraction machines comprising an integrated electrolysis technology is not yet available, which can produce a slightly alkaline brewing water comprising a tripled or quadrupled solvency and traction power and a doubled or tripled cell resorption potential for the ingredients of the extract for increasing the quality of a coffee or tea beverage by means of electrolytic full diamond electrodes, which are doped with boron or other suitable electrodes comprising an electric overpotential.

### EMBODIMENT OF THE INVENTION

The invention shall be shown using the example of a conventional coffee-tea machine, consisting of the following technical components and parts: (see drawing ANNEX 1)

A Liquid container comprising filler neck comprising cover made of a non-oxidizing material. Automatic water-level control. Connecting piece or hose to booster pump comprising integrated automatic return flow shut-off valve.

B Electrolytic cell supplied with approximately 36 Volts of electric voltage integrated in the pump intake port upstream of booster pump.

C Water pressure increase pump with approx. 12-15 atm pressurization, approx. 0.5 liters of throughput per minute, preferably 110 or 220 V, respectively, comprising connecting hose to electrolytic cell(s) comprising diamond electrodes (or of another suitable electrode material comprising electric overpotential).

D Water heating coil or heating cylinder.

E Extraction container, capsule or filter pad chamber.

F Spout for coffee and hot water comprising a separate steam generator nozzle.

G Electric ON/ OFF switch, control electronics for liquid control, coffee quantum switch, coffee level gauge or capsule or filter pad disposal mechanism, coffee ground emptying or rinsing

H Power plug 110V/220V 50-60 Hz

I 1 or a plurality of connecting hoses comprising fixing brackets to electrolytic cell(s)

K 1 or a plurality of electrolytic cells comprising 2 or a plurality of diamond electrodes or corresponding suitable stable metal electrodes, each comprising 2 plus/minus connecting sleeves and in each case plus/minus 2 electrical cables to electrical distribution station comprising fuse box and in each case connected to the spray valves of the windshield wiper sprayer via a hose.

L 1 electrical control of the electrolytic cell(s) comprising electrode dipole reversal.

M In each case 2 electrical connecting cables plus/minus to electrolytic cell(s)

N Electrical control comprising programming station

### Operation of a Coffee-Tea Machine

Coffee is the number one national beverage. The myths entwined around harmful effects for the human organism resulting from drinking coffee, have meanwhile been disproven. Ninety percent of the people in this country answer the question tea or coffee with “coffee”. Whether for breakfast, at a cozy coffee klatsch at home, in a café or in the office—coffee is the most popular beverage. Approximately 320 million cups of coffee are consumed in Germany alone. However, opinions differ when it comes to preparation. The most common method is and remains the coffee machine. In this country, no kitchen or office can survive without it any longer. The filter coffee is brewed conventionally in this manner. More than ninety percent of all German households own a coffee machine. And there is still a demand—almost seven million electric coffee machines are soled each year in Germany alone. Coffee machines serve to semi-automatically prepare coffee. If one wants to provide a technical definition of the coffee machine, it can be described as a device for thermally extracting and filtering coffee beans. Water is used as extractant. Special coffee filters, capsules or filter pads serve as filter thereby.

However, the good old coffee machine has meanwhile been replaced in some places by modern fully-automatic coffee machines. As the name suggests, these machines prepare the coffee fully automatically, that is, they regulate the water supply and the coffee supply automatically. The coffee is filled into mugs or cups directly from the machine. The coffee grounds move into the grounds container automatically.

### Mode of Operation of Coffee Machines

But how exactly does this semi-automatic preparation of the coffee work, using a conventional coffee machine? What processes run thereby in the interior of the machine, invisible for the observer? The mode of operation of a coffee machine is as follows: initially, the desired amount of water, which then corresponds approximately to the quantity of the brewed coffee, must be filled into the water tank. In addition, the filter must be filled with the adequate amount of ground coffee, the so-called coffee powder, or a capsule (Nespresso) or a round filter pad must be placed into the extraction chamber. After starting the coffee machine, the water from the water tank then runs into the heating system, a continuous-flow heater, by means of a pressure pump in the suction hose via the simultaneously electrically activated electrolytic cell comprising the corresponding electrodes and via a non-return flow valve, which is installed in the supply hose. In the case of most of the coffee machines, this heater is located below the hot plate. There, the water is heated to such an extent within a very short period of time that steam bubbles form. For the most part, these are temperatures of between 90 and 95 degrees Celsius. Pressure is built up in this manner and the non-return flow valve closes. The coffee is now pumped via a riser pipe into a pivotable pipe, which ends above the filter. Fresh water then flows into the heating element. The process is repeated as soon as enough pressure has again been built up by the steam. The hot water then runs through the filter across the ground coffee. The significant parts of the processes, which now run, are the extraction and the filtration. The hot, slightly alkaline water equipped with numerous dipole water molecules causes the pressure-induced and thermal extraction, the substance break-up, in that it acts as solvent, which draws the soluble portions of the coffee out of the coffee powder. The coffee filter thereby holds back the particles, which are larger than the pores of the filter. The flavors and thus the taste of the coffee unfold here. The result is freshly-brewed coffee without traces of coffee powder. The finished coffee then runs directly from the filter into the cups(s) or coffeepot located therebelow.

1. An electrically operated coffee-tea extraction machine, consisting of water container, connecting hose, comprising integrated electrolytic cell comprising full diamond electrodes or other stable, suitable metal electrodes comprising electric overpotential, pressure increase water pump comprising riser pipe and integrated return flow stop valve, water heating coil or heating cylinder comprising lines, comprising extraction chamber for powder coffee or tea, capsules or round filter pads comprising manual or automatic ejection, comprising coffee ground, capsule or round filter container and integrated electrical control comprising ON/OFF push buttons and electrical connecting cable for the production of slightly alkaline electrolyte water and electrochemically separated water molecule clusters comprising 2 to 3 molecules for improving the sensory perception and tripled or quadrupled extractive capacity of the brewing water and for increasing the intestinal cell resorption of the extracted ingredients of coffee and tea beverages.

2. The electrically operated coffee-tea extraction machine according to claim 1, consisting of:
(according to drawing in ANNEX 1)
A Liquid containers comprising filler neck comprising cover made of a non-oxidizing material. Automatic water-level control. Connecting piece or hose to the booster pump comprising an integrated automatic return flow shut-off valve.
B Electrolytic cell supplied with approximately 36 Volts of electric voltage integrated in the pump intake port upstream of booster pump.
C Water pressure increase pump with approx. 12-15 atm pressurization, approx. 0.5 liters of throughput per minute, preferably 110 or 220 V, respectively, comprising connecting hose to electrolytic cell(s) comprising diamond electrodes (or of another suitable electrode material comprising electric overpotential).
D Water heating coil or heating cylinder.
E Extraction container, capsule or filter pad chamber
F Spout for coffee and hot water comprising a separate steam generator nozzle.
G Electric ON/ OFF switch, control electronics for liquid control, coffee quantum switch, coffee level gauge or capsule or filter pad disposal mechanism, coffee ground emptying or rinsing
H Power plug 110V/220V 50-60 Hz
I 1 or a plurality of connecting hoses comprising fixing brackets to electrolytic cell(s)
K 1 or a plurality of electrolytic cells comprising 2 or a plurality of diamond electrodes or corresponding suitable stable metal electrodes, each comprising 2 plus/minus connecting sleeves and in each case plus/minus 2 electrical cables to electrical distribution station comprising fuse box and in each case connected to the water container and the water booster pump of the coffee-tea machine.
L 1 electrical control of the electrolytic cell(s) comprising electrode dipole reversal.
M In each case 2 electrical connecting cables plus/minus to electrolytic cell(s)
N Electrical control comprising programming station

3. The coffee-tea extraction machine according to claims 1 equipped according to the drawing figure K in Appendix 1 comprising 1 or a plurality of electrolytic cells comprising 2 or a plurality of diamond electrodes or corresponding suitable stable metal electrodes, in each case comprising 2 plus/minus connecting sleeves and in each case plus/minus 2 electrical cables to electrical distribution station comprising fuse box and in each case connected to the water container and the water booster pump of the coffee-tea machine via the hose.

4. The coffee-tea extraction machine according to claims 1, characterized in that the device is additionally equipped with an electrical control, figure L according to the drawing in Appendix 1 for the electrode dipole reversal in the electrolytic cell, which ensures an automatic cleaning.

5. The coffee-tea extraction machine according to claims 1, according to drawing figure K in Appendix I equipped with 1 or a plurality of electrolytic cells comprising 2 or more diamond electrodes or corresponding suitable stable metal electrodes for producing slightly alkaline water having a pH of 8.2-8.6 and for electrochemically breaking up the water molecule cluster chains of 14-18 molecules into clusters containing 2 to 3 molecules per cluster, characterized in that the solvency and extractive capacity of the brewing water in the coffee-tea machine triples or quadruples and the intestinal cell resorption potential through membranes doubles or triples. On the one hand, said improved parameters make the extraction efficiency of coffee and tea powder in the machine in combination with heat and pressure more efficient, resulting in substantially improved extraction of flavors and ingredients of coffee and tea and an optimal sensory quality of the beverages with respect to the acidity and bitterness of coffee and tea and, on the other hand, resorption of the ingredients through intestinal cell membranes is improved and two to three times faster. Moreover, the enormous extractive capacity of said combined technology makes it possible to admix probiotics, plant substances to the coffee powder or tea powder in order to obtain an added nutritional benefit besides providing the enjoyment of a tasty beverage.
